(19) United States
(12) Patent Application Publication
(10) Pub. No.: US 2022/0127035 A1
(43) Pub. Date: Apr. 28, 2022

(54) System and Method for Printing Labels and Applying a Printed Overlaminated Label Set on an Object

(71) Applicant: COLLINDER MÄRKSYSTEM AB, Lomma (SE)

(72) Inventor: Mika Canter, Upplands Väsby (SE)

(73) Assignee: COLLINDER MÄRKSYSTEM AB, Lomma (SE)

(21) Appl. No.: 17/291,712

(22) PCT Filed: Nov. 6, 2019
(86) PCT No.: PCT/SE2019/051113

§ 371 Date: May 6, 2021

(30) Foreign Application Priority Data
Nov. 9, 2018 (SE) 1851400-0

(51) Int. Cl. B65C 9/46; B65C 9/44; B65C 9/18; G09F 3/02

(52) U.S. Cl. CPC B65C 9/46; B65C 9/44; G09F 2003/0255; G09F 3/02; B65C 9/1865

(57) ABSTRACT

The present invention relates to a method for printing labels and applying a laminated printed label on to an object 3, where the method comprises the steps of a label printer 21 printing on the label in a position for printing, and a label applicator 22 applying the label on the object 3. The inventive method is adapted to function with a liner 1 where every other label is of a first kind and every other label is of a second kind. The label printer 21 prints on every label of the first kind and allows every label of the second kind to pass without printing, and the label applicator 22 applies every label of the first kind to the object 3, and applies every label of the second kind on top of the previously applied label of the first kind.

### TECHNICAL FIELD

The present invention relates to a method for printing labels and applying a laminated printed label on an object, where the method comprises the steps of the label printer printing on the label in the position for printing, and the label applicator applying the label on the object.

The present invention also relates to a system adapted to function according to the inventive method, and to computer program products comprising computer program code which when executed by a computer enables the computer to control a system into performing the inventive method.

### BACKGROUND ART

In harsh environmental conditions, such as mechanical wear, chemical exposure, exposure to low and/or high temperatures, sun or ultra violet exposure, it is known to produce laminated labels where the laminate protects the label so that it can for fulfil the high requirements and expectations that are put on labels in such harsh environmental conditions.

It is known to manually apply an over-laminate to a printed label. Parallel liners are used with one liner for labels to be printed on and a parallel liner for the laminate. After printing in the label for printing the pair of labels are disconnected from the liner, the printed label is attached to the object to be labelled, and the laminate is positioned over the printed label. It is known to only apply the printed label partially to the object and to use the printed label still partially attached to the liner to align the laminate over the printed label and partially apply the laminate over the still only partially applied label, where after the both the printed label and the laminate is fully detached from the liner and applied to the object. This is a manual and very time-consuming process, which require high accuracy in the manual process to get a satisfactory result. This method does not allow for automatic application of the over-laminate on top of the printed label, nor the automatic application of the over-laminated label on to the product.

There are a few brands and different types of manually over-laminated labels, which all have in common that the require manual labour, and cannot be automated. Known brands for manual types of over-laminating labels are Brady and CCL Design.

It is known to use labels that are not laminated in automated processes, and it is also known to use pre-printed, pre-over-laminated labels that are adapted for auto-apply applications.

### SUMMARY OF THE PRESENT INVENTION

### Problems

It is a technical problem to apply over-laminated labels manually. It is an labour-intensive and time consuming process.

It is also a problem to apply laminated labels with high precision where there are very high expectations on the positioning of the label on to the object. One problem is the tolerance of the laminate on top of the base label, and another is the positioning of the label set on top of the object that is to be labelled.

It is a problem to enables the printing of a label in real time, to provide the label with an over-laminate, and to apply the label on to an object in an automatic environment.

### Solution

With the purpose of solving one or several of the above problems, and on the basis of prior art such as it has been shown above and the indicated technical field, the present invention teaches that the method is adapted to function with a liner with labels where every other label is of a first kind and every other label is of a second kind. The invention teaches that the label printer prints on every label of the first kind and allows every label of the second kind to pass without printing in the step of printing, and that the label applicator applies every label of the first kind to the object, and applies every label of the second kind on top of the previously applied label of the first kind in the step of applying.

The label printer may locate a label of a first kind in different ways. It is proposed that the label printer locates the label of a first kind through an initial position of the liner with labels and of a label of the first kind on the liner with labels, or by means of a first detector, which first detector locates:
the position of a label on the liner with labels; or
a first indication on the liner with labels, where the first indication indicates the position of the first kind of labels on the liner with labels.

The label applicator may also locate the labels in different ways.

As an example it can be mentioned that the label applicator may locate a label of the first kind and a label of the second kind through the position for each label of the first kind as located by the label printer, and through the position of a label of the second kind in relation to a label of the first kind.

It is also possible that the label applicator locates a label of the first kind through the position for each label of the first kind as located by the label printer, and that the label applicator locates the label of a second kind by means of a second detector, which second detector locates:
the position of a label on the liner with labels; or
a first indication on the liner with labels, where the first indication indicates the position of the first kind of labels on the liner with labels; or
a second indication on the liner with labels, where the second indication indicates the position of the second kind of labels on the liner with labels.

Another proposed embodiment teaches that the label applicator locates the label of a first kind by means of a first detecting unit belonging to a second detector, and that the label applicator locates the label of a second kind by means of a second detecting unit belonging to the second detector, where the first detecting unit locates:
the position of a label on the liner with labels; or
a first indication on the liner with labels, where the first indication indicates the position of the first kind of labels on the liner with labels;
   and that the second detecting unit locates:
the position of a label on the liner with labels; or
a second indication on the liner with labels, where the second indication indicates the position of the second kind of labels on the liner with labels.

Objects to which an over-laminated label has been applied are to be moved out of position for application to allow for another object to be moved into position for application. Hence, the inventive method comprises the steps of feeding a first object to which a label has been applied out of a position for application after a completed application of the label, and feeding a second object into the position for application.

The step of feeding objects include maintaining the position of the first object after application of a label of the first kind and feeding the first object out of the position for application after application of a label of the second kind.

It is proposed that the first object can be positioned into several different positions for application of a laminated printed label on the first object before feeding the first object out of position for application and feeding the second object into the position for application.

It is also proposed that depending on the level of automation of the lamination process the steps of feeding is performed automatically by an automatic object feeder, or manually by an operator.

The present invention also relates to a system for printing labels and applying a laminated printed label on to an object, the system comprising a label printer and a label applicator. The label printer is adapted to print on the label in the position for printing and the label applicator is adapted to apply the label on the object.

The inventive system is adapted to function with a liner with labels where every other label is of a first kind and every other label is of a second kind. The label printer is adapted to print on every label of the first kind and allow every label of the second kind to pass without printing, and the label applicator is adapted to apply every label of the first kind to the object, and to apply every label of the second kind on top of the previously applied label of the first kind.

The label printer can be adapted to locate a label on the liner with labels in different ways. According to one proposed embodiment the label printer is adapted to locate the label of a first kind through an initial position of the liner with labels, and of a label of the first kind on the liner with labels, in the system.

It is also possible that the label printer comprises a first detector, which first detector is adapted to locate:
the position of a label on the liner with labels; or
a first indication on the liner with labels, where the first indication indicates the position of the first kind of labels on the liner with labels.

It is in the same way possible for the label applicator to locate a label on the liner with labels in different ways. According to one proposed embodiment the label applicator is adapted to locate a label of the first kind and a label of the second kind through the position for each label of the first kind as located by the label printer, and through the position of a label of the second kind in relation to a label of the first kind.

It is also proposed that the label applicator is adapted to locate a label of the first kind through the position for each label of the first kind as located by the label printer, and that the label applicator comprises a second detector, which second detector is adapted to locate:
the position of a label on the liner with labels; or
a first indication on the liner with labels, where the first indication indicates the position of the first kind of labels on the liner with labels; or
a second indication on the liner with labels, where the second indication indicates the position of the second kind of labels on the liner with labels.

Another proposed embodiment teaches that the label applicator comprises a second detector, which second detector comprises a first and a second detecting unit, where the first detecting unit is adapted to locate:
the position of a label on the liner with labels; or
a first indication on the liner with labels, where the first indication indicates the position of the first kind of labels on the liner with labels;
   and where the second detecting unit is adapted to locate:
the position of a label on the liner with labels; or
a second indication on the liner with labels, where the second indication indicates the position of the second kind of labels on the liner with labels.

The system may comprise an object feeder, which object feeder can be adapted to:
feed a first object to which a label has been applied out of a position for application after a completed application of the label, and
feed a second object into the position for application.

The present invention specifically teaches that the object feeder is adapted to maintain the position of the first object after application of a label of the first kind and feeding the first object out of the position for application after application of a label of the second kind.

The object feeder may also be adapted to position the first object into several different positions for application of a laminated printed label on the first object before feeding the first object out of position for application and feeding the second object into the position for application.

The object feeder can be adapted to be controlled manually by an operator, or it can be adapted to automatic control.

The inventive method and system are adapted to use a specific liner with labels for printing and application to an object, and the present invention also relates to such liner with labels, where it is taught that every other label on the liner is of a first kind and every other label on the liner is of a second kind, where the first kind of label is adapted for printing, and where the second kind of label is adapted to cover and laminate a printed label of the first kind.

It is proposed that the liner can be marked with a first indicator which indicates the position of each label of the first kind. The liner may also be marked with a second indicator which indicates the position of each label of the second kind.

The first and/or second indicator can be a hole, slot or notch in the liner, or it can be a mark or line printed on the front or rear side of the liner.

It is also proposed that the material of the label of the second kind is adapted to lamination and protection of the label of the first kind.

The present invention also relates to a first computer program product comprising first computer program code which, when executed by a computer controlling a label printer, enables the label printer to perform the steps of a label printer according to the inventive method.

The present invention also relates to a second computer program product comprising second computer program code which, when executed by a computer controlling a label applicator, enables the label applicator to perform the steps of a label applicator according to the inventive method.

The present invention also relates to a third computer program product comprising third computer program code which, when executed by a computer controlling an object feeder, enables the object feeder to perform the steps of an object feeder adapted to automatic control according to the inventive method.

The present invention also relates to a main computer program product comprising computer program code which, when executed by a main computer controlling a label printer, a label applicator and an object feeder adapted to automatic control, enables the label printer, label applicator and object feeder to perform the steps of a label printer, label applicator and object feeder adapted to automatic control according to the inventive method.

The present invention also relates to a computer readable medium carrying computer program code according to any one of the inventive computer program products.

### Advantages

The advantages that foremost may be associated with a method, system and computer program product according to the present invention are that the automatic printing and applying of the label set saves time, but still provides an over-laminated label on the product without the need for intensive manual labour in the process.

The inventive method, system and computer program product provides an automated process that can solve the manual limitations with tolerances and placement, as well as save time compared with traditional label lamination. It also enables the user to print their own data on demand, in combination with getting a durable, over-laminated label on their product

The over-laminate provides cover for the printed label, which protects it from harsh environments, such as, but not limited to: UV-light, the elements outdoors, abrasion, as well as the influence by chemicals getting in contact with the label. The production cost of the label set is also reduced, as the production process of the label set is less complex, compared to manual versions of over-laminated label sets.

### BRIEF DESCRIPTION OF THE DRAWINGS

A method, a system computer program products, and a computer readable medium having the properties associated with the present invention will now be described in more detail for the purpose of exemplifying, reference being made to the accompanying drawing, wherein:

FIG. 1 shows a diagram illustrating the inventive method,

FIG. 2 shows schematically a liner with labels according to the invention,

FIG. 3 is a simplified and schematic illustration of a system according to the present invention, and

FIG. 4 is a simplified and schematic illustration of a computer program product and a computer readable medium according to the present invention.

### DETAILED DESCRIPTION OF PREFERRED EMBODIMENTS

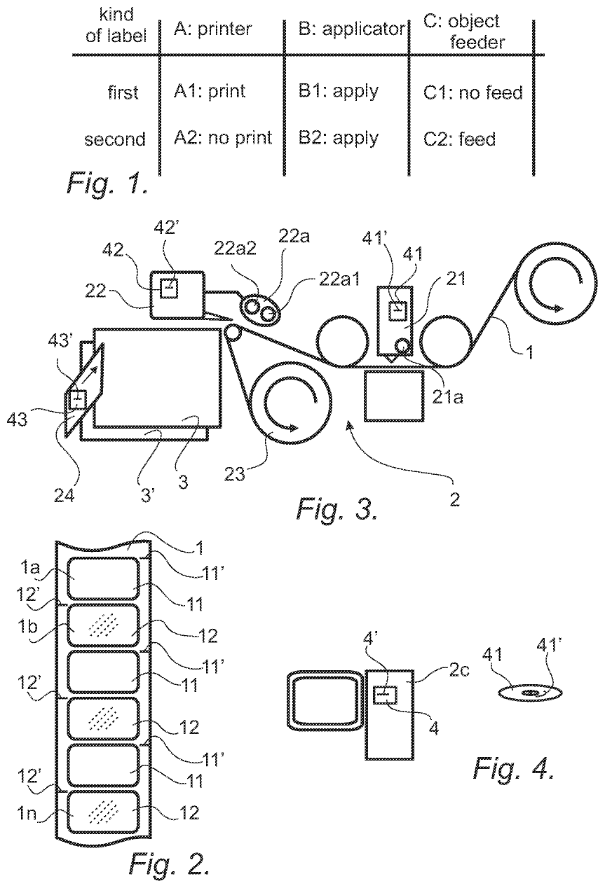

In the following, the present invention will be described with a reference to FIG. 1 illustrating a method for printing labels and applying a laminated printed label on to an object, where said method comprises the steps of:

A a label printer printing on said label in a position for printing, and

B a label applicator applying the label on the object.

FIG. 2 shows a liner 1 with labels 1a, 1b, . . . 1n. The invention specifically teaches that the method is adapted to function with a liner 1 where every other label is of a first kind 11 and every other label is of a second kind 12.

FIG. 3 is a schematic and simplified illustration of a system 2 for printing labels, with a label printer 21 and a label applicator 22. An object 3 is also shown in FIG. 3.

The label printer 21 prints A1 on every label of the first kind 11 and allows every label of the second kind 12 to pass without printing A2 in the step of printing A, and the label applicator 22 applies B1 every label of the first kind 11 to the object 3, and applies B2 every label of the second kind 12 on top of the previously applied label of the first kind 11 in the step of applying B.

As a result, there will be an over-laminated label on the object 3.

FIG. 1 shows the printing and application process for one over-laminated label, and it should be understood that this is repeated for every over-laminated label that is produced according to the inventive method. The step of printing A and applying B can be performed in the same process, or they can be performed separately, where printing A is performed first and where printed labels are stored for a later step of application B.

It should be understood that some kind of liner feeder 23 can be used to feed the liner 1 and this can be implemented in many different ways, however, the invention is not dependent on how this liner feeder 23 functions or is controlled.

It should also be understood that there are different kinds of printers that can be used as a label printer in the present invention. It is known to use thermal transfer printing or inkjet printing, the invention is however not depending on what kind of printer technique that is used.

It is known how a label printer can locate a label for printing, and many different ways of locating a label can be used by the present inventions.

However, the present invention require that the first kind of labels 11 can be distinguished from the second kind of labels 12.

Different ways of separating the first kind of labels 11 from the second kind of labels 12 will be exemplified with reference to FIG. 3.

One proposed embodiment is that the label printer 21 locates the label of a first kind 11 for printing through an initial position of the liner 1 with labels 1a, 1b, . . . , 1n and the original position of a label of the first kind 11 on the liner 1 with labels. This can be done by an initial setting of the liner 1 with labels in the system 2 for printing labels where a label of the first kind 11 is correctly positioned for printing, after which initial setting, and with knowledge of the size on the labels and the distance between the labels, the label printer can be controlled to print only on every label of the first kind 11.

It is also possible that the label printer 21 locates the label of a first kind 11 for printing by means of a first detector 21a, which first detector 21a locates the position of an actual label 1a, 1b, . . . , 1n on the liner with labels 1. One known detector for detecting the position of a label on the liner with labels is a so called see-through sensor system, where the sensor system illuminates the liner from one side of the liner and detects light on the other side of the liner, and where detected light indicates a space between labels and obstructed light indicates a label. This embodiment still requires that there is an initiating setup where a label of the first kind 11 is positioned for detection, after which initial setting the label printer can be controlled to print only on every label of the first kind 11.

Another proposed embodiment teaches that the first detector 21a locates a first indication 11′ on the liner with labels 1, where the first indication 11′ indicates the position of the first kind of labels 11 on the liner with labels 1.

There are different kinds of label applicators 22 where some pick up a label for application directly from the label printer 21 and where the position of the label is known through the known position from the label printer.

Hence it is proposed that the label applicator 22 locates a label of the first kind 11 and a label of the second kind 12 through the position for each label of the first kind 11 as located by the label printer 21, and through the position of a label of the second kind 12 in relation to a label of the first kind.

It is also possible that the label applicator 22 locates a label of the first kind 11 through the position for each label of the first kind 11 as located by the label printer 21, and that the label applicator 22 locates the label of a second kind 12 by means of a second detector 22a, which second detector 22a locates:
the position of a label 11a, 11b, 11 n on the liner with labels 1, or
a first indication 11′ on the liner with labels 1, where the first indication 11′ indicates the position of the first kind of labels 11 on the liner with labels 1; or
a second indication 12′ on the liner with labels 1, where the second indication 12′ indicates the position of the second kind of labels 12 on the liner with labels 1.

There are applications where printing on labels of the first kind is performed for a liner with labels, which liner with printed labels of the first kind is stored for later use in an application of labels on to an object. Hence the printing A and application B may be performed in two separate processes. For this reason, and for other reasons where the label applicator 22 do not, or cannot, use the knowledge of the position of the labels from the label printer 21, it is important that the label applicator 22 can determine the position of the labels on the liner with labels 1.

Hence it is proposed that the label applicator 22 locates the label of a first kind 11 by means of a first detecting unit 22a1 belonging to a second detector 22a, that the label applicator locates the label of a second kind 12 by means of a second detecting unit 22a2 belonging to the second detector 22a, where the first detecting 22a1 unit locates:
the position of a label 1a, 1b, . . . , 1n on the liner with labels 1; or
a first indication 11′ on the liner with labels 1, where the first indication 11′ indicates the position of the first kind of labels 11 on the liner with labels 1;
   and that the second detecting unit 22a2 locates:
the position of a label 1a, 1b, . . . , 1n on the liner with labels 1; or
a second indication 12′ on the liner with labels 1, where the second indication 12′ indicates the position of the second kind of labels 12 on the liner with labels 1.

Objects to which an over-laminated label has been applied are to be moved out of position for application to allow for another object to be moved into position for application. Hence, the inventive method comprises the steps of feeding C a first object 3 to which a label has been applied out of a position for application after a completed application of the label, and feeding a second object 3′ into the position for application.

The step of feeding objects C include maintaining the position of the first object C1 after application of a label of the first kind 11 and feeding the first object out of the position for application C2 after application of a label of the second kind 12.

It is proposed that the first object 3 can be positioned into several different positions for application of a laminated printed label on the first object before feeding the first object out of position for application C2 and feeding the second object into the position for application.

It is also proposed that depending on the level of automation of the lamination process the steps of feeding is performed automatically by an automatic object feeder 24, or manually by an operator.

An inventive system for printing labels and applying a laminated printed label on to an object 3 will now be described, which system 2 comprises a label printer 21, and a label applicator 22, where the label printer 21 is adapted to print on the label 11, and where the label applicator 22 is adapted to apply the label 11 on the object 3.

The system is adapted to function with a liner 1 where every other label is of a first kind 11 and every other label is of a second kind 12. The label printer 21 is adapted to print on every label of the first kind 11 and to allow every label of the second kind 12 to pass without printing. The label applicator 22 is adapted to apply every label of the first kind 11 to the object 3, and to apply every label of the second kind 12 on top of the previously applied label of the first kind 11.

A liner feeder 23 can be adapted to feed the liner 1 with labels to the label printer 21 and to the label applicator 22.

An object feeder 24 is adapted to feed objects out of and into the position for application, and it is known that the object feeder 24 receives a go signal from the applicator 22 after completed application of the label to enable the object feeder to know when to feed objects out of and into the position for application.

The label printer 21 can be adapted to locate the label of a first kind 11 through an initial position of the liner with labels 1, and of the position of a label of the first kind 11 on the liner with labels 1, in the system.

The label printer 21 may, however, comprise a first detector 21a, which is adapted to locate:
the position of a label 1a, 1b, . . . , 1n on the liner with labels 1; or
a first indication 11′ on the liner with labels 1, where the first indication 11′ indicates the position of the first kind of labels 11 on the liner with labels 1.

The label applicator 22 may be adapted to locate a label of the first kind 11 and a label of the second kind 12 through the position for each label of the first kind 11 as located by the label printer 21, and through the position of a label of the second kind 12 in relation to a label of the first kind 11. This is a known way of locating a label in systems where the applicator 22 picks a label 1a, 1b, . . . , 1n as soon as it exits the printer 21, in which case no separate detection of a label is required by the applicator 22.

It is however possible that the label applicator 22 is adapted to locate a label of the first kind 11 through the position for each label of the first kind 11 as located by the label printer 21, and that the label applicator comprises a second detector 22a, which is adapted to locate the position of a label on the liner with labels, or a first indication on the liner with labels, where the first indication indicates the position of the first kind of labels on the liner with labels, in which case it is required also that the relative position of labels on the liner is known.

It is also possible that the second detector 22a is adapted to locate a second indication 12′ on the liner with labels 1, where the second indication 12′ indicates the position of the second kind of labels 12 on the liner with labels 1.

It is also possible that label applicator 22 comprises a second detector 22a, which second detector 22a comprises a first 22a1 and a second 22a2 detecting unit, where the first detecting unit 22a1 is adapted to locate:
the position of a label 1a, 1b, . . . , 1n on the liner with labels 1; or
a first indication 11′ on the liner with labels 1, where the first indication 11′ indicates the position of the first kind of labels 11 on the liner with labels 1;
   and that the second detecting unit 22a2 is adapted to locate:
the position of a label 1a, 1b, . . . , 1n on the liner with labels 1; or
a second indication 12′ on the liner with labels 1, where the second indication 12′ indicates the position of the second kind of labels 12 on the liner with labels 1.

It is proposed that the system 2 may comprise an object feeder 24, where the object feeder 24 is adapted to:
feed a first object 3 to which a label has been applied out of a position for application after a completed application of the label, and
feed a second object 3′ into the position for application.

The invention teaches that the object feeder 24 is adapted to maintain the position of the first object 3 after application of a label of the first kind 11 and feed the first object 3 out of the position for application after application of a label of the second kind 12.

With the purpose of allowing the application of several over-laminated labels on the same object, it Is proposed that the object feeder 24 is adapted to position the first object 3 into several different positions for application of a laminated printed label on the first object 3 before feeding the first object 3 out of position for application and feeding the second object 3′ into the position for application.

The object feeder 24 can be adapted to be controlled either manually by an operator or it can be adapted to automatic control.

The present invention require a liner of labels 1 that is adapted to be used in a method, or by a system, according to the invention. Hence, the present invention also relates to a liner 1 with labels for printing and application to an object 3, where every other label on the liner 1 is of a first kind 11 and every other label on the liner 1 is of a second kind 12, and where the first kind of label 11 is adapted for printing, and the second kind of label 12 is adapted to cover and laminate a printed label of the first kind 11.

The inventive liner may be marked with a first indicator 11′ which indicates the position of each label of the first kind 11.

The liner may also be marked with a second indicator 12′ which indicates the position of each label of the second kind 12.

In FIG. 2 the first indicator 11′ and the second indicator 12′ are illustrated as a marking on the liner. However, it should be understood that the first and/or second indicator 11′, 12′ may be a hole, slot or notch in the liner. The first and/or second indicator 11′, 12′ may also be a mark or line printed on the front or rear side of the liner, as illustrated in FIG. 2.

The material of the label of the second kind 12 is adapted to lamination and protection of the label of the first kind 11, and the label of the first kind is adapted to be printed upon.

It should be understood that it is possible to print information on each label of the first kind in a step for printing A as described, and store the liner with labels where each label of the first kind holds the printed information for later use. This liner with labels where each label of the first kind holds the printed information can then be used for the application of over-laminated labels on to an object in a later step for application. Hence the present invention also relates to a liner where each label of the first kind holds printed information.

The present invention also relates to a first computer program product 41 comprising first computer program code 41′ which, when executed by a computer 21c controlling a label printer 21, enables the label printer 21 to perform the steps of a label printer 21 according to the inventive method.

The present invention also relates to a second computer program product 42 comprising second computer program code 42′ which, when executed by a computer 22c controlling a label applicator 22, enables the label applicator 22 to perform the steps of a label applicator 22 according to the inventive method.

The present invention also relates to a third computer program product 43 comprising third computer program code 43′ which, when executed by a computer 24c controlling an object feeder 24, enables the object feeder 24 to perform the steps of an object feeder 23 adapted to automatic control according to the inventive method.

It is known that the printer 21 and applicator 22, and also the liner feeder 23 and in some cases the object feeder 24, can be integrated into one unit, where printing and application is performed through one initial identification of the label and in one step, and where this unit is controlled by one computer or several internal computer units.

FIG. 4 shows a main computer 2c and the present invention also relates to a main computer program product 4 comprising computer program code 4′ which, when executed by a main computer 2c controlling a label printer 21, a label applicator 22 and an object feeder 24, enables the label printer 21, label applicator 22 and object feeder 24 to perform the steps of a label printer 21, label applicator 22 and object feeder 24 according to the inventive method.

The invention also relates to a computer readable medium 41, such as a non-volatile computer readable medium, in FIG. 4 schematically illustrated by a compact disc, carrying computer program code 41′ according to any one of the inventive computer program products.

The invention is of course not limited to the embodiments given above as examples but may be subjected to modifications within the scope of the general idea according to the invention such as this is shown in the subsequent claims.

1-32. (canceled)

33. A method for printing labels and applying a laminated printed label on to an object, where said method comprises the steps of:
a label printer printing on said label in a position for printing, and
a label applicator applying said label on said object,
characterised in, that said method is adapted to function with a liner with labels where every other label is of a first kind and every other label is of a second kind, that said label printer prints on every label of said first kind and allows every label of said second kind to pass without printing in said step of printing, and that said label applicator applies every label of said first kind to said object, and applies every label of said second kind on top of the previously applied label of said first kind in said step of applying.

34. The method according to claim 33, characterised in, that said label printer locates said label of a first kind for printing through an initial position of said liner with labels and of a label of said first kind on said liner with labels, or that said label printer locates said label of a first kind for printing by means of a first detector, which first detector locates:
the position of a label on said liner with labels; or
a first indication on said liner with labels, where said first indication indicates the position of said first kind of labels on said liner with labels.

35. The method according to claim 33, characterised in, that said label applicator locates a label of said first kind and a label of said second kind through the position for each label of said first kind as located by said label printer, and through the position of a label of said second kind in relation to a label of said first kind, or that said label applicator locates a label of said first kind through the position for each label of said first kind as located by said label printer, and that said label applicator locates said label of a second kind by means of a second detector, which second detector locates:
the position of a label on said liner with labels; or
a first indication on said liner with labels, where said first indication indicates the position of said first kind of labels on said liner with labels; or
a second indication on said liner with labels, where said second indication indicates the position of said second kind of labels on said liner with labels,
or that said label applicator locates said label of a first kind by means of a first detecting unit belonging to a second detector, that said label applicator locates said label of a second kind by means of a second detecting unit belonging to said second detector, that said first detecting unit locates:
the position of a label on said liner with labels; or
a first indication on said liner with labels, where said first indication indicates the position of said first kind of labels on said liner with labels;
and that said second detecting unit locates:
the position of a label on said liner with labels; or
a second indication on said liner with labels, where said second indication indicates the position of said second kind of labels on said liner with labels.

36. The method according to claim 33, where said method comprises the steps of:
feeding a first object to which a label has been applied out of a position for application after a completed application of said label; and
feeding a second object into said position for application;
characterised in, said maintaining the position of said first object after application of a label of said first kind and feeding said first object out of said position for application after application of a label of said second kind.

37. The method according to claim 36, characterised in, positioning said first object into several different positions for application of a laminated printed label on said first object before feeding said first object out of position for application and feeding said second object into said position of application.

38. A system for printing labels and applying a laminated printed label on to an object, said system comprising a label printer, and a label applicator, where said label printer is adapted to print on said label, and where said label applicator is adapted to apply said label on said object, characterised in, that said system is adapted to function with a liner with labels where every other label is of a first kind and every other label is of a second kind, that said label printer is adapted to print on every label of said first kind and allow every label of said second kind to pass without printing, and that said label applicator is adapted to apply every label of said first kind to said object, and to apply every label of said second kind on top of the previously applied label of said first kind.

39. The system according to claim 38, characterised in, that said label printer is adapted to locate said label of a first kind through an initial position of said liner with labels, and of a label of said first kind on said liner with labels, in said system, or that said label printer comprises a first detector, and that said first detector is adapted to locate:
the position of a label on said liner with labels; or
a first indication on said liner with labels, where said first indication indicates the position of said first kind of labels on said liner with labels.

40. The system according to claim 39, characterised in, that said label applicator is adapted to locate a label of said first kind and a label of said second kind through the position for each label of said first kind as located by said label printer, and through the position of a label of said second kind in relation to a label of said first kind,
or that said label applicator is adapted to locate a label of said first kind through the position for each label of said first kind as located by said label printer, that said label applicator comprises a second detector, and that said second detector is adapted to locate:
the position of a label on said liner with labels; or
a first indication on said liner with labels, where said first indication indicates the position of said first kind of labels on said liner with labels; or
a second indication on said liner with labels, where said second indication indicates the position of said second kind of labels on said liner with labels,
or that said label applicator comprises a second detector, that said second detector comprises a first and a second detecting unit, that said first detecting unit is adapted to locate:
the position of a label on said liner with labels; or
a first indication on said liner with labels, where said first indication indicates the position of said first kind of labels on said liner with labels;
and that said second detecting unit is adapted to locate:
the position of a label on said liner with labels; or
a second indication on said liner with labels, where said second indication indicates the position of said second kind of labels on said liner with labels.

41. The system according to claim 38, where said system comprises an object feeder, where said object feeder is adapted to:
feed a first object to which a label has been applied out of a position for application after a completed application of said label, and
feed a second object into said position for application,
characterised in, said object feeder is adapted to maintain the position of said first object after application of a label of said first kind and feeding said first object out of said position for application after application of a label of said second kind.

42. The system according to claim 41, characterised in, that said object feeder is adapted to position said first object into several different positions for application of a laminated printed label on said first object before feeding said first object out of position for application and feeding said second object into said position for application.

43. A liner with labels for printing and application to an object, characterised in, that every other label on said liner is of a first kind and every other label on said liner is of a second kind, that said first kind of label is adapted for printing, that said second kind of label is adapted to cover and laminate a printed label of said first kind, and that the material of said label of said second kind is adapted to lamination and protection of said label of said first kind.

44. The liner according to claim 43, characterised in, that said liner is marked with a first indicator which indicates the position of each label of said first kind.

45. The liner according to claim 44, characterised in, that said liner is marked with a second indicator which indicates the position of each label of said second kind.

46. The liner according to claim 43, characterised in, that each label of said first kind holds printed information.

47. A first computer program product comprising first computer program code which, when executed by a computer controlling a label printer, enables said label printer to perform the steps of a label printer according to claim 33.

48. A second computer program product comprising second computer program code which, when executed by a computer controlling a label applicator, enables said label applicator to perform the steps of a label applicator according to claim 33.

49. A third computer program product comprising third computer program code which, when executed by a computer controlling an object feeder, enables said object feeder to perform the steps of an object feeder adapted to automatic control according to claim 36.

50. A main computer program product comprising computer program code which, when executed by a main computer controlling a label printer, a label applicator and an object feeder, enables said label printer, label applicator and object feeder to perform the steps of a label printer, label applicator and object feeder according to claim 33.

51. A computer readable medium carrying computer program code according to claim 47.
